(19) United States
(12) Patent Application Publication
(10) Pub. No.: US 2017/0097521 A1
(43) Pub. Date: Apr. 6, 2017

(54) OPTICAL PRODUCT AND SPECTACLE LENS

(71) Applicant: Tokai Optical Co., Ltd., Okazaki-Shi (JP)

(72) Inventors: Takuro YOSHIDA, Okazaki-Shi (JP); Hirotoshi TAKAHASHI, Okazaki-Shi (JP)

(21) Appl. No.: 14/872,299

(22) Filed: Oct. 1, 2015

(51) Int. Cl. G02C 7/10; G02B 1/11; G02B 5/28

(52) U.S. Cl. CPC G02C 7/107; G02B 5/283; G02B 5/285; G02B 1/11; G02C 7/104; G02C 2202/16

(57) ABSTRACT

[Object] An optical product and a spectacle lens are provided which allow both blue light and ultraviolet rays to be cut off while visibility is made advantageous.

[Solution] An optical product (spectacle lens) of the present invention includes: a base; and an optical multilayer film formed on a surface of the base. The optical multilayer film includes six or more layers in which a low refractive index layer and a high refractive index layer are alternately disposed in which a first layer is closest to the base, and a final layer is the low refractive index layer. The final layer includes an optical film thickness M and a layer adjacent to the final layer includes an optical film thickness N, in which a sum M+N of the optical film thickness M and the optical film thickness N satisfies conditions of [1] 0.295λ≦M≦0.415λ and [2] 0.460λ≦M+N≦0.560λ, respectively, when a design wavelength λ=500 nm is satisfied.

### FIELD OF THE INVENTION

The present invention relates to optical products having antireflection films that reflect ultraviolet rays and blue light, and that prevent reflection of light, in a visible region, having wavelengths longer than a wavelength of the blue light, and to spectacle lenses as an example of the optical product.

### BACKGROUND OF THE INVENTION

As antireflection films (optical multilayer films) that reflect one of blue light or ultraviolet rays and prevent reflection of light in the other visible regions, films described in Patent Literatures 1 and 2 have been known.

The antireflection film described in Patent Literature 1 is structured to have eight layers in which a layer closest to a transparent substrate is the first layer, the eighth layer is a low refractive index layer and has a film thickness that is greater than or equal to 0.22λ₀ and not greater than 0.30λ₀ (λ₀ represents a design wavelength, and is, for example, 520 nanometers (nm)), and the seventh layer is a high refractive index layer and has a film thickness that is greater than or equal to 0.16λ₀ and not greater than 0.22λ₀, so that ultraviolet rays are reflected.

In the multilayer film described in Patent Literature 2, an average reflectance is 2% to 10% for a wavelength range (blue light) of 400 nm to 500 nm, and the average reflectance of the multilayer film arranged on a convex surface of a plastic base material is made higher than the average reflectance of the multilayer film arranged on a concave surface.

### PRIOR ART DOCUMENT

[Patent Literature 1] Japanese Patent No. 4171362
[Patent Literature 2] Japanese Patent No. 5173076

### SUMMARY OF INVENTION

### Technical Problem

The antireflection film described in Patent Literature 1 has an improved ultraviolet shielding function while the antireflection film is not sufficient in blue light shielding.

In the multilayer film described in Patent Literature 2, the average reflectance for the wavelength range of 400 nm to 500 nm is 2% to 10%, and blue light is reflected to some degree while ultraviolet rays are not sufficiently reflected.

In recent years, since LED lighting, monitors having LED backlight, mobile devices, and the like have been widespread, it is suggested that eyes be protected from blue light (for example, light having a wavelength of 380 nm to 500 nm). The blue light is at the short wavelength in a wavelength region of visible light (visible region of, for example, 380 nm to 780 nm), and has relatively high energy, and therefore it is assumed that load on eyes is increased. Further, among visible light, the blue light is more likely to be scattered, is scattered also in eyes relatively well, and has glare which is relatively strongly felt. Therefore, it is suggested that blue light be cut off by, for example, a spectacle lens having some degree of reflectance for a wavelength region (blue light region) of blue light, thereby protecting eyes.

On the other hand, regarding ultraviolet rays, as described in [0005] of Patent Literature 1, a shielding film is used for optical components of a stepper using a liquid crystal projector, an ultraviolet lamp, and/or an excimer laser, while ultraviolet rays are not cut off by a spectacle lens or the like provided with an ultraviolet shielding film. Ultraviolet rays are cut off by ultraviolet absorber being kneaded in a plastic base in a plastic spectacle lens, and ultraviolet rays are not cut off at a glass lens. Further, even in a plastic spectacle lens, ultraviolet rays are not cut off at various films provided on the outer surface of the plastic base, and are transmitted through the films.

Ultraviolet rays have a wavelength that is shorter than blue light, and have higher energy, and it is assumed that load on eyes is further increased. Ultraviolet rays have a wavelength other than wavelengths in the visible region, and do not contribute to visibility. Therefore, it is preferable that ultraviolet rays are cut off as much as possible. On the other hand, blue light has a wavelength in the visible region and contributes to visibility. Therefore, blue light needs to be cut off to some degree while visibility is to be taken into consideration.

An object of the inventions described in claim 1 to claim 5 is to provide an optical product and a spectacle lens that allow both blue light and ultraviolet rays to be cut off while visibility is made advantageous.

### Solution to Problem

In order to attain the above-mentioned object, the invention described in claim 1 is an optical product that includes a base and an optical multilayer film formed on a surface of the base. The optical multilayer film includes six or more layers in which a low refractive index layer and a high refractive index layer are alternately disposed where a first layer is closest to the base and a final layer is the low refractive index layer. Further, the optical multilayer film includes the final layer having an optical film thickness M and a layer adjacent to the final layer having an optical film thickness N, in which a sum M+N of the optical film thickness M and the optical film thickness N satisfies both conditions of [1] 0.295λ≦M≦0.415λ, and [2] 0.460λ≦M+N≦0.560λ, respectively, when a design wavelength λ=500 nm is satisfied.

According to the invention described in claim 2, in the above invention, in the optical multilayer film, an average reflectance for light in a range of wavelengths that are greater than or equal to 280 nm and not greater than 380 nm, is greater than or equal to 50% and not greater than 86%, and an average reflectance for light in a range of wavelengths that are greater than or equal to 380 nm and not greater than 500 nm, is greater than or equal to 15% and not greater than 26%.

According to the inventions described in claims 3 and 4, in the above invention, in the optical multilayer film, an average reflectance for light in a range of wavelengths that are greater than or equal to 500 nm and not greater than 700 nm, is less than or equal to 1.0%.

According to the inventions described in claims 5 to 8, in the above invention, a luminous reflectance (D65 light source, viewing angle of 2 degrees) in the optical multilayer film is less than or equal to 1.0%.

The inventions described in claims 9 to 16 are a spectacle lens including the optical product described above, and the base is a spectacle lens base.

### Advantageous Effects of Invention

According to the present invention, an effect of providing an optical product and a spectacle lens which allow both blue light and ultraviolet rays to be cut off while visibility is made advantageous, can be achieved.

### BRIEF DESCRIPTION OF THE DRAWINGS

FIG. 1 is a graph showing a distribution of reflectance according to Examples A1 to A3.

FIG. 2 is an enlarged view of FIG. 1.

FIG. 3 is a graph showing a distribution of reflectance according to Examples A4 to A6.

FIG. 4 is an enlarged view of FIG. 3.

FIG. 5 is a graph showing a distribution of reflectance according to Examples A7 to A9.

FIG. 6 is an enlarged view of FIG. 5.

FIG. 7 is a graph showing a distribution of reflectance according to Examples A10 to A12.

FIG. 8 is an enlarged view of FIG. 7.

FIG. 9 is a graph showing a distribution of reflectance according to Comparative examples A1 to A4.

FIG. 10 is an enlarged view of FIG. 9.

FIG. 11 is a graph showing a distribution of reflectance according to Examples B1 to B3.

FIG. 12 is an enlarged view of FIG. 11.

FIG. 13 is a graph showing a distribution of reflectance according to Examples B4 to B6.

FIG. 14 is an enlarged view of FIG. 13.

FIG. 15 is a graph showing a distribution of reflectance according to Examples B7 to B9.

FIG. 16 is an enlarged view of FIG. 15.

FIG. 17 is a graph showing a distribution of reflectance according to Examples B10 to B12.

FIG. 18 is an enlarged view of FIG. 17.

FIG. 19 is a graph showing a distribution of reflectance according to Examples B13 to B15.

FIG. 20 is an enlarged view of FIG. 19.

FIG. 21 is a graph showing a distribution of reflectance according to Comparative examples B1 to B4

FIG. 22 is an enlarged view of FIG. 21.

### DETAILED DESCRIPTION OF THE INVENTION

An embodiment of the present invention will be described below. Embodiments of the present invention are not limited to the embodiment described below.

An optical product is a convex lens, and has a convex surface (front surface) and a concave surface (rear surface). Alternatively, the optical product is a flat lens or a concave lens, and has a front surface and a rear surface. The optical product includes a base having a front surface and a rear surface, and an optical multilayer film formed on at least the front surface of the base.

A material of the base may be any material such as glass or plastic. Plastic is preferably used. Examples of the material of the base include a polyurethane resin, an episulfide resin, a polycarbonate resin, an acrylic resin, a polyether sulfone resin, a poly(4-methylpentene-1) resin, and a diethylene glycol bis(allyl carbonate) resin.

Typical examples of the optical product include spectacle lenses such as spectacle plastic lenses or spectacle glass lenses. Other examples of the optical product include camera lenses, projector lenses, binocular lenses, telescope lenses, and various filters. In the case of a spectacle lens, the base is a spectacle lens base.

The optical multi layer film may be formed directly on the front surface of the base, or may be formed, via a single or plural intermediate film such as a hard coating layer, on the front surface of the base. The hard coating layer is formed of, for example, an organosiloxane or other organosilicon compound, or an acrylic compound. A primer layer may be formed below the hard coating layer. The primer layer is formed of at least one of, for example, a polyurethane-based resin, an acrylic resin, a methacrylic resin, and an organosilicon resin.

The optical multilayer film formed on the base has, in total, six layers, or seven or more layers in which a high refractive index material and a low refractive index material are alternately layered. The high refractive index material is, for example, titanium oxide, and the low refractive index material is, for example, silicon dioxide (SiO₂). As the low refractive index material and the high refractive index material, MgF₂ (magnesium difluoride), Al₂O₃ (dialuminum trioxide), Y₂O₃ (diyttrium trioxide), ZrO₂ (zirconium dioxide), Ta₂O₅ (ditantalum pentoxide), HfO₂ (hafnium dioxide), Nb₂O₅ (niobium pentoxide), a combination thereof, or the like can be used.

In the optical multilayer film, a first layer is disposed closest to the base, and the low refractive index material is disposed in a final layer (outermost layer). A single or plural outer films such as a water repellent film may be further formed outward of the optical multilayer film.

The optical multilayer film is formed by, for example, physical vapor deposition such as a vacuum deposition method or a sputtering method. In the vacuum deposition method, various gases such as inert gas may be supplied at the deposition, conditions (an amount to be supplied, pressure at film forming, or the like) for supplying the gases may be controlled, an ion-assisted method in which various ions are introduced at a predetermined acceleration voltage or acceleration current when the film is formed may be implemented, or plasma treatment may be performed when the film is formed.

The final layer (low refractive index layer) of the optical multilayer film is produced such that an optical film thickness is greater than or equal to 0.295λ, and not greater than 0.415λ (λ represents a design wavelength, and is, for example, 500 nm). That is, when the optical film thickness of the final layer is represented as M,

0.295λ≦M≦0.415λ,

is satisfied.

Further, a sum of the optical film thickness of the final layer and an optical film thickness of a layer (high refractive index layer) adjacent to the final layer is set to be greater than or equal to 0.460λ and not greater than 0.560λ. That is, when the optical film thickness of the layer adjacent to the final layer is represented as N,

0.460λ≦M+N≦0.560λ

is satisfied.

The optical product having such an optical multilayer film on one surface or both surfaces, has the following characteristics.

That is, an average reflectance (hereinafter, referred to as an “ultraviolet average reflectance”) for light in a range of wavelengths that are greater than or equal to 280 nm and not greater than 380 nm, is greater than or equal to 50% and not greater than 86%.

Further, an average reflectance (hereinafter, referred to as a “blue light average reflectance”) for light in a range of wavelengths that are greater than or equal to 380 nm and not greater than 500 nm, is greater than or equal to 15% and not greater than 26%.

Furthermore, an average reflectance (hereinafter, referred to as a “central-section-in-visible-region average reflectance”) for light in a range of wavelengths that are greater than or equal to 500 nm and not greater than 700 nm, is less than or equal to 1.0%.

In addition, a luminous reflectance (D65 light source, viewing angle of 2 degrees) is less than or equal to 1.0%.

When the ultraviolet average reflectance is greater than or equal to 50% and not greater than 86%, and the blue light average reflectance is greater than or equal to 15% and not greater than 26%, both blue light and ultraviolet rays can be cut off.

Further, when the central-section-in-visible-region average reflectance is less than or equal to 1.0% or the luminous reflectance is less than or equal to 1.0%, an optical multilayer film (optical product) has a reflection prevention function so that excellent visibility can be obtained. Further, when the average reflectance for light in a range of wavelengths that are greater than or equal to 380 nm and not greater than 500 nm, is greater than or equal to 15% and not greater than 26%, since blue light is not cut off beyond necessity (cut off to an intermediate degree), visibility can be advantageously assured.

On the other hand, when the optical film thickness M of the final layer is less than 0.295λ, the central-section-in-visible-region average reflectance is greater than 1.0%, and excellent visibility cannot be assured.

Further, when M is greater than 0.415λ, the central-section-in-visible-region average reflectance is greater than 1.0% or the luminous reflectance is greater than 1.0%, and excellent visibility cannot be assured.

Furthermore, when a sum M+N of the optical film thickness M of the final layer and the optical film thickness N of the layer (a layer that is one layer inward of the final layer) adjacent to the final layer is less than 0.460λ, the central-section-in-visible-region average reflectance is greater than 1.0% or the luminous reflectance is greater than 1.0%, and excellent visibility cannot be assured.

Moreover, when M+N is greater than 0.560λ, the ultraviolet average reflectance is less than 50%, and the central-section-in-visible-region average reflectance is greater than 1.0% or the luminous reflectance is greater than 1.0%. Therefore, an excellent ultraviolet shielding function or excellent visibility cannot be assured.

When film thicknesses of the layers other than the final layer and the layer adjacent thereto are designed as appropriate in a state where various conditions for the optical multilayer film of the present invention are satisfied, an optical product that allows both blue light and ultraviolet rays to be cut off with excellent visibility (reflection prevention performance), can be provided.

Further, adjustment is performed such that a color of light reflected by the optical multilayer film formed on the front surface advantageously matches a color of light reflected by the front surface of the base or the other films. Thus, when the lens or a person (for example, a wearer of the spectacle lens) having the lens is seen from the outside, colors of the light reflected by the lens are harmonized, so that a good appearance is provided without flicker. Further, flicker in color of light observed through the lens is reduced also for the person having the lens, and seeing of light through the lens is facilitated. The optical multilayer film may be formed on the concave surface (rear surface) in the same manner as for the convex surface (front surface) such that equivalent films are formed on the front and rear surfaces.

### Examples

Next, various examples and the like of the optical multilayer film (optical product) will be described.

For two film types (film type A, B) described below, a plurality of examples according to the present invention and a plurality of comparative examples that do not belong to the present invention were made.

In the film type A, the film has, in total, six layers in which the low refractive index material is SiO₂, the high refractive index material is ZrO₂, and the first layer closest to the base is formed of ZrO₂. The final layer is formed of SiO₂, and the layer adjacent thereto is formed of ZrO₂.

In the film type B, the film has, in total, seven layers in which the low refractive index material is SiO₂, the high refractive index material is TiO₂, and the first layer closest to the base is formed of SiO₂. The final layer is formed of SiO₂, and the layer adjacent thereto is formed of TiO₂.

The optical multilayer films of the film types A and B (all the examples and all the comparative examples) are each formed on both surfaces of each of lens bases having the same structure. The lens base is formed of a thiourethane resin, and the refractive index is 1.60, the Abbe number is 42, and the power is −0.00 (substrate in which the convex surface and the concave surface have the same curve).

Table 1 indicated below indicates the optical film thicknesses (L1 to L6) of the respective layers, and a sum (L5+L6 corresponding to M+N as described above) of the optical film thicknesses of the final layer and the layer adjacent thereto in each film according to Examples A1 to A6 for the film type A. Table 2 indicates the optical film thicknesses of the respective layers and the like according to Examples A7 to A12 for the film type A. Table 3 indicates the optical film thicknesses of the respective layers and the like according to Comparative examples A1 to A4 for the film type A.

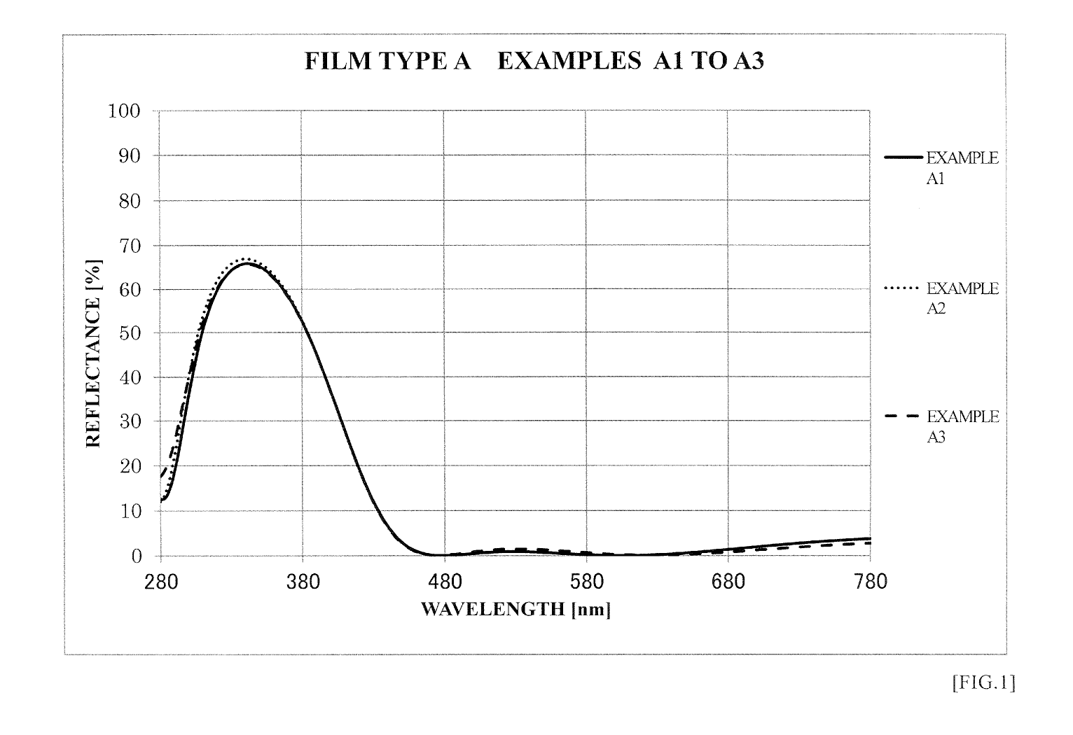

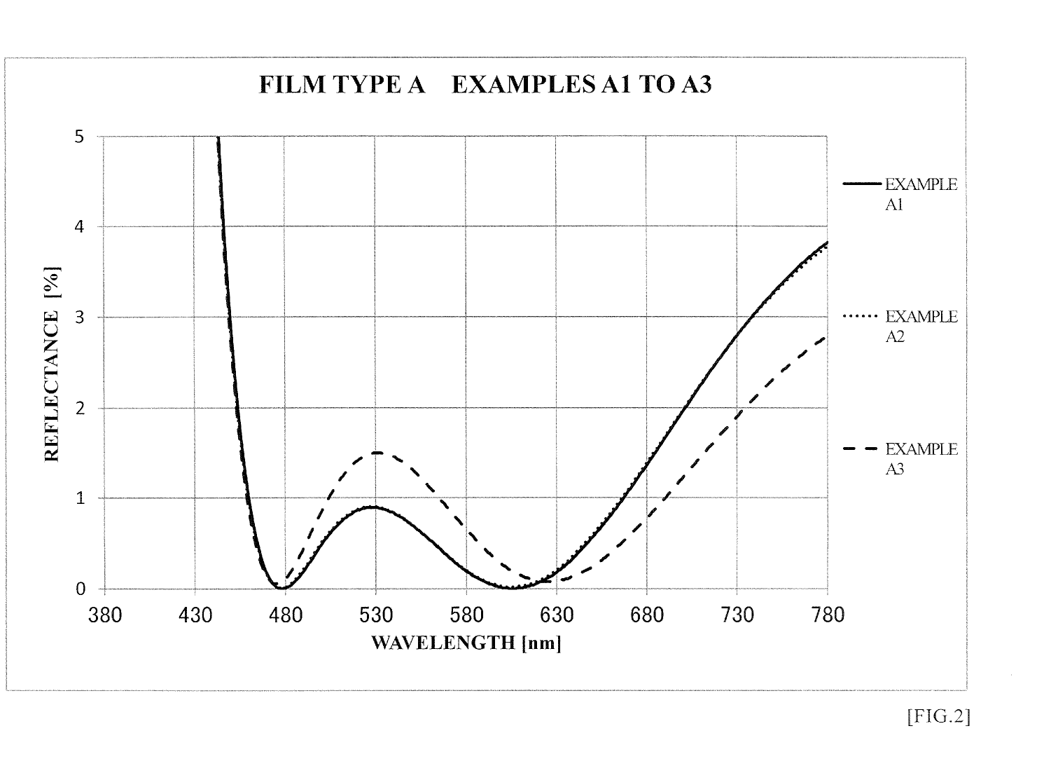

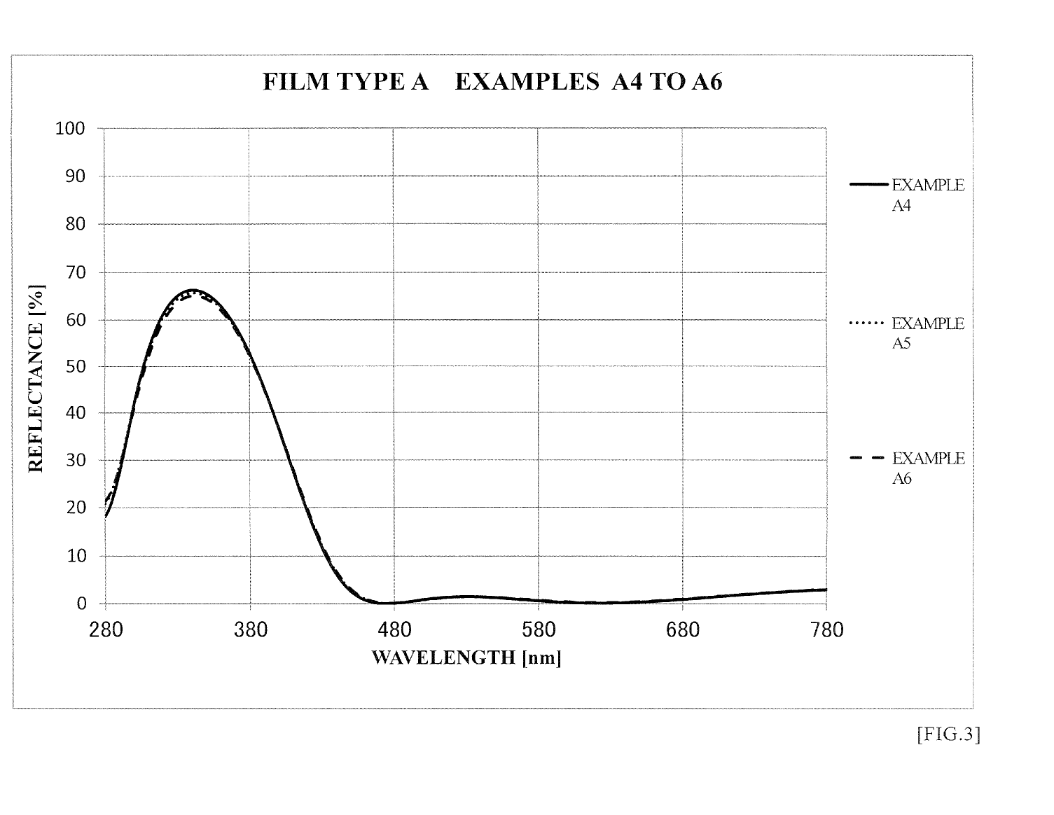

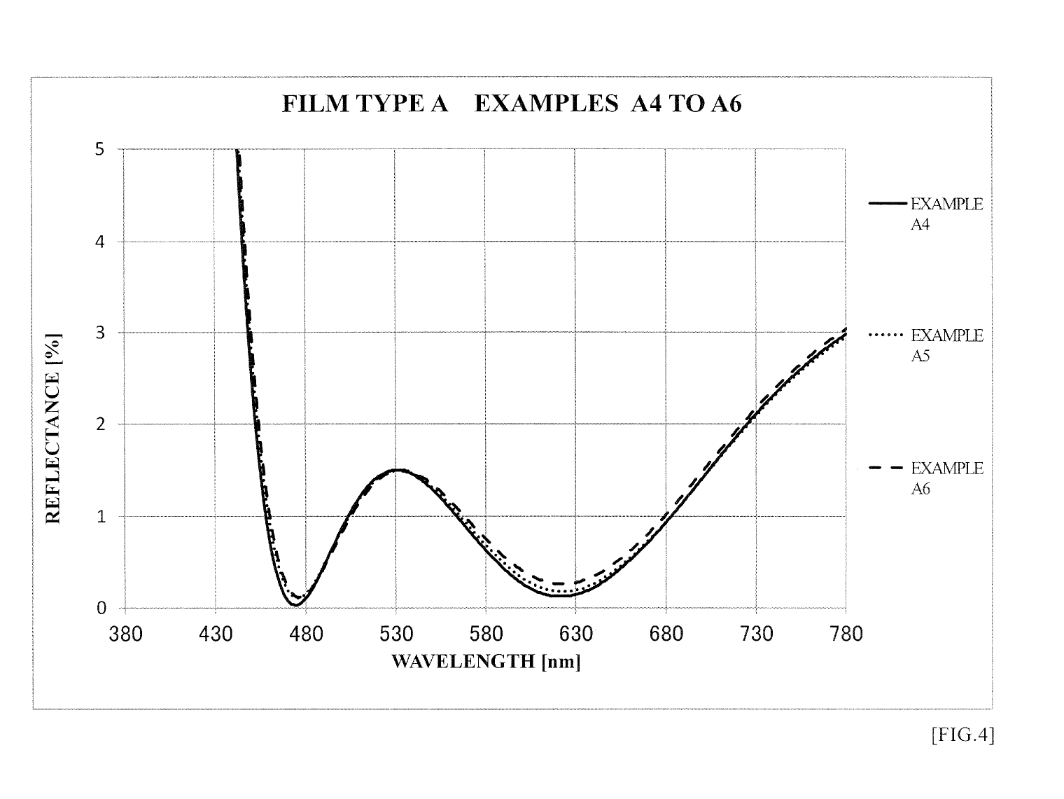

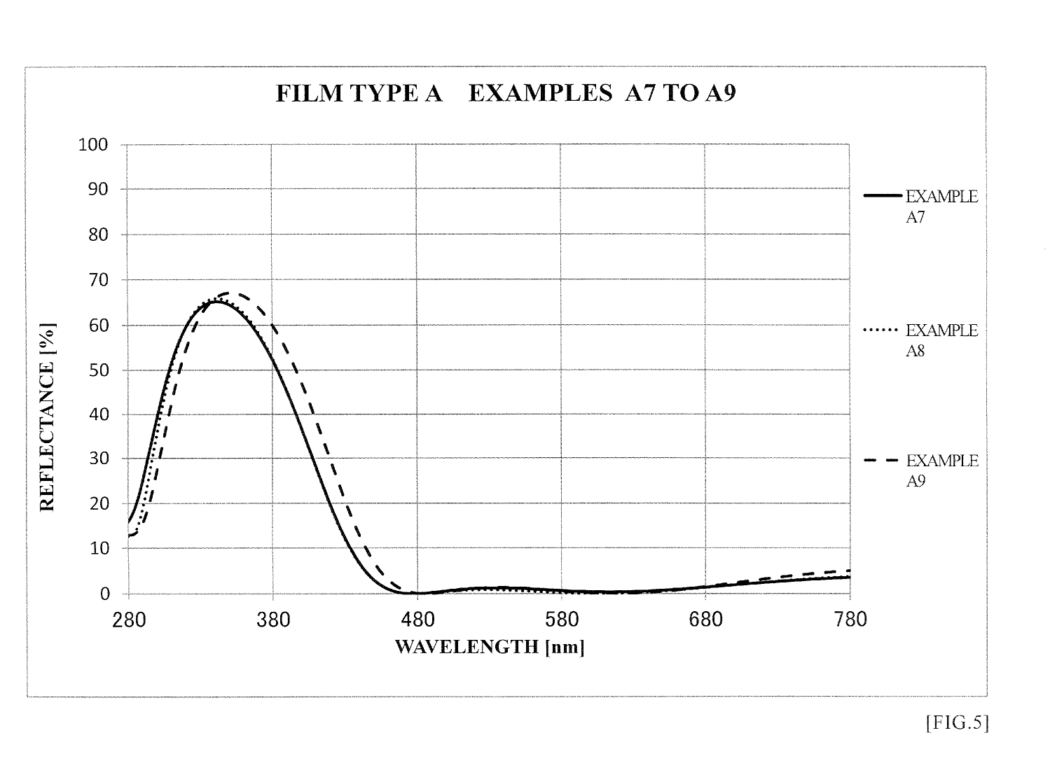

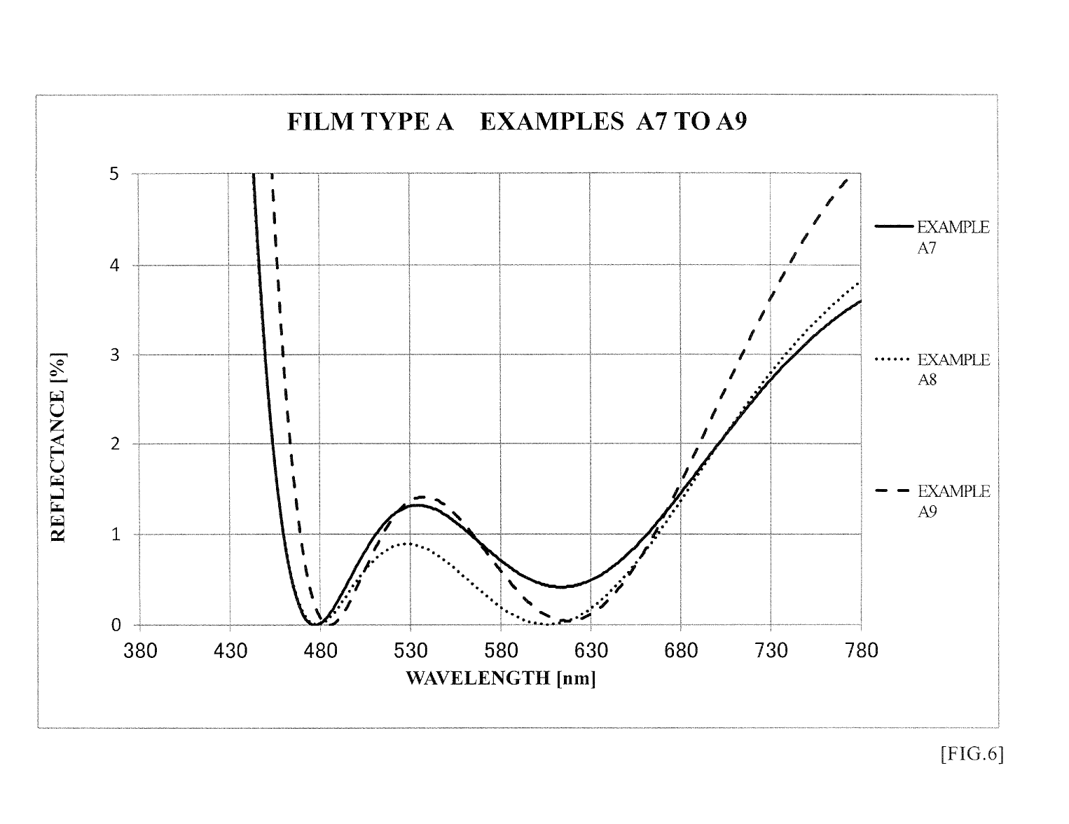

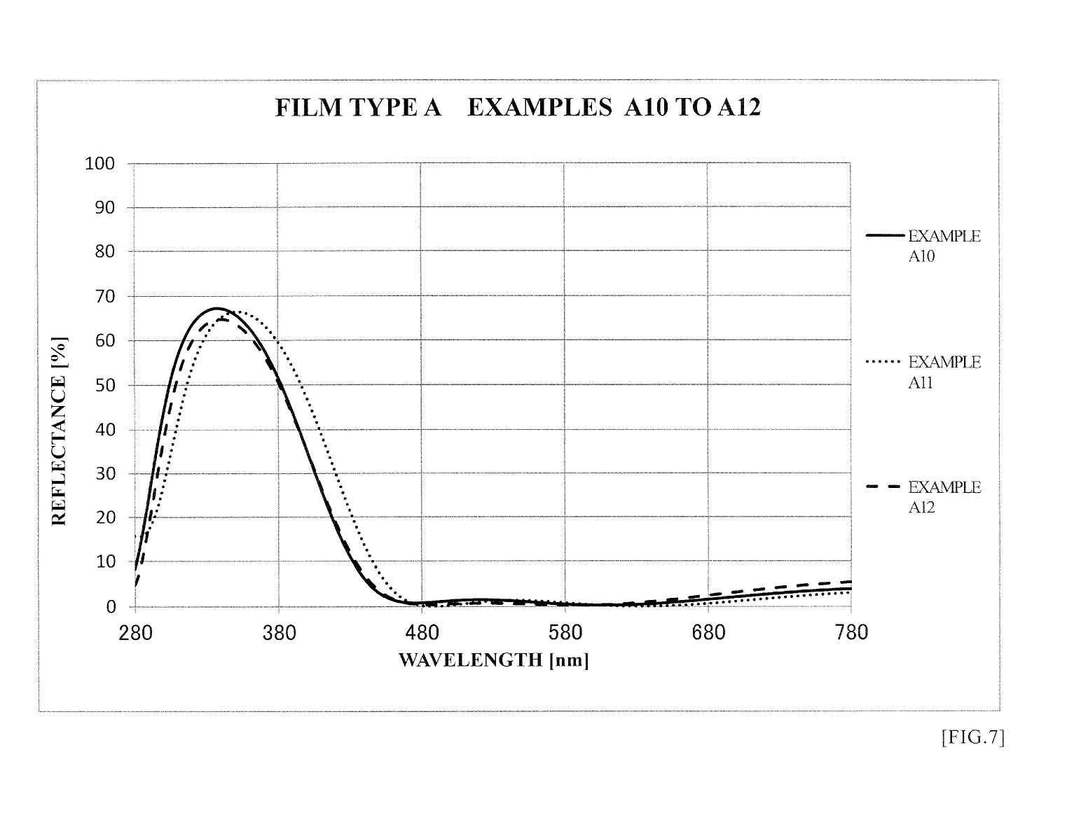

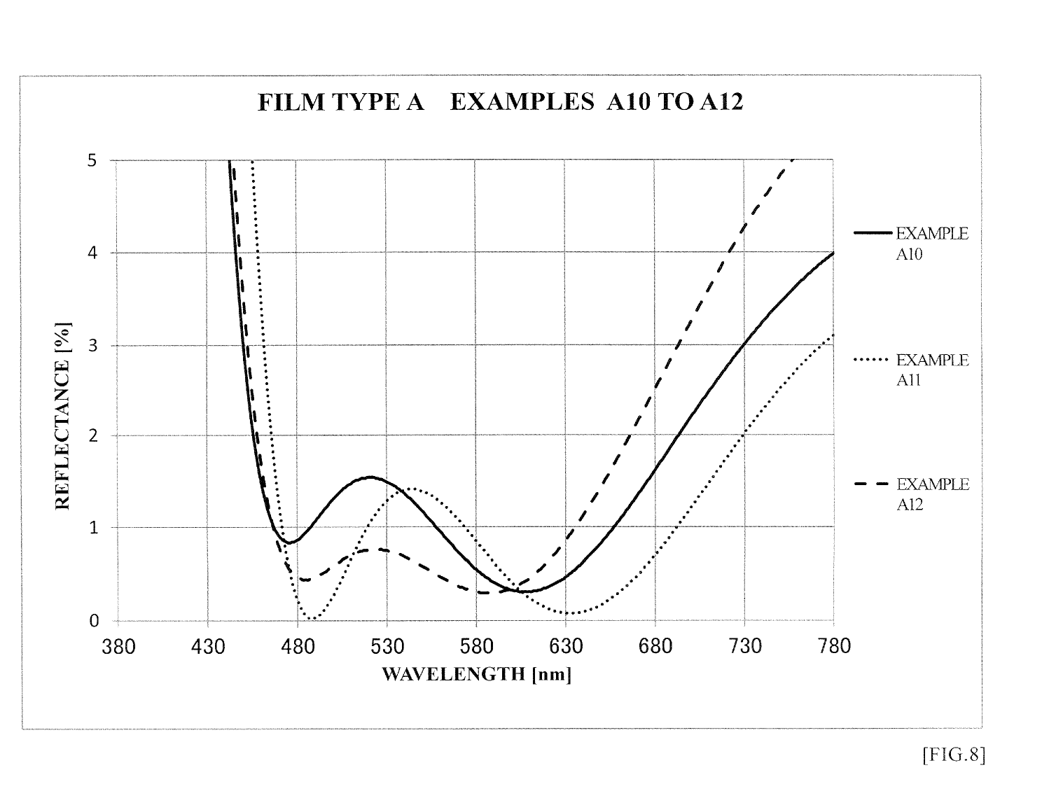

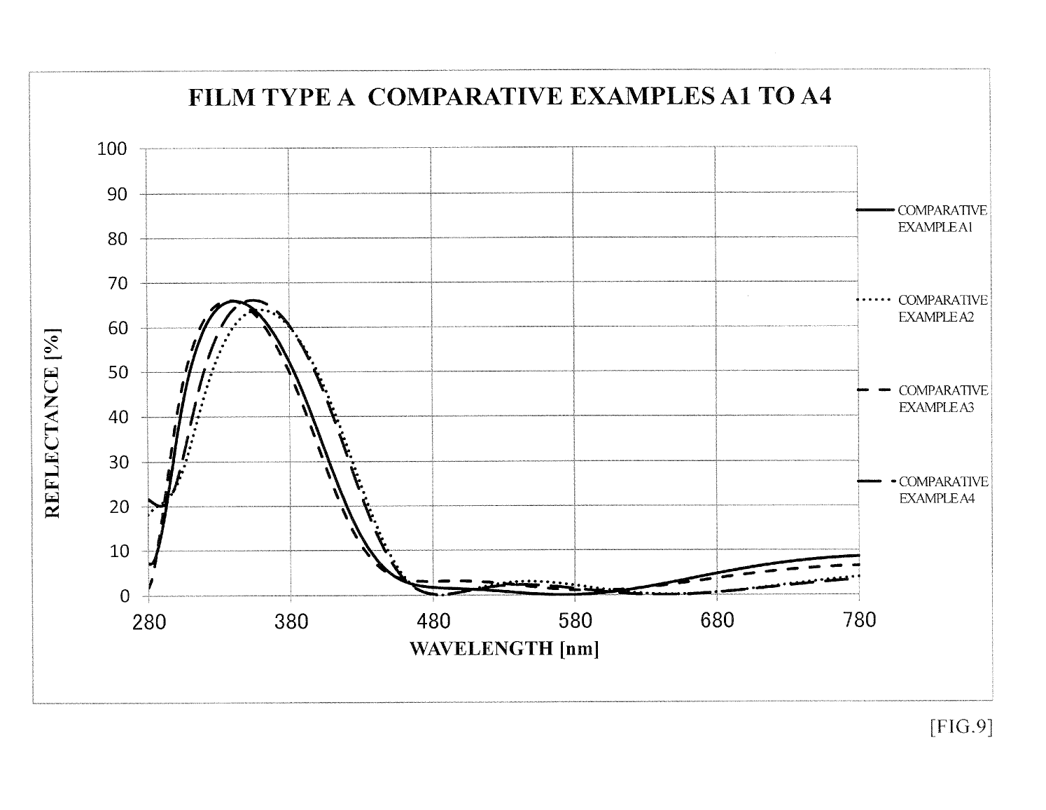

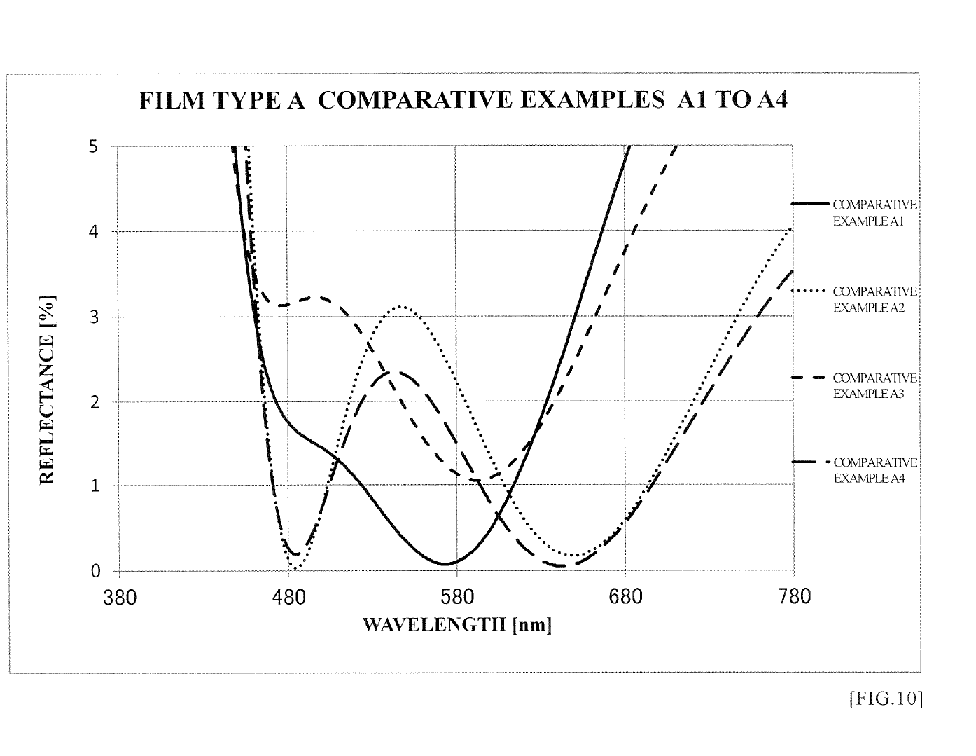

Further, FIG. 1 is a graph showing a distribution of reflectance in a range from the ultraviolet region to the visible region according to Examples A1 to A3. FIG. 2 is an enlarged view (a graph in which the vertical axis represents the reflectance of 0% to 5%, and the horizontal axis represents a wavelength starting from 380 nm) of FIG. 1. FIG. 3 is a graph showing a distribution of reflectance according to Examples A4 to A6, and FIG. 4 is an enlarged view of FIG. 3. FIG. 5 is a graph showing a distribution of reflectance according to Examples A7 to A9, and FIG. 6 is an enlarged view of FIG. 5. FIG. 7 is a graph showing a distribution of reflectance according to Examples A10 to A12, and FIG. 8 is an enlarged view of FIG. 7. Further, FIG. 9 is a graph showing a distribution of reflectance according to Comparative examples A1 to A4, and FIG. 10 is an enlarged view of FIG. 9.

TABLE 1

| Film structure | | | | | | | | |
|---|---|---|---|---|---|---|---|---|
| | | Refractive | Example | Example | Example | Example | Example | Example |
| Layer | Material | index | A1 | A2 | A3 | A4 | A5 | A6 |
| | | | Optical film thickness (×λ) | | | | | |
| L1 | ZrO2 | 2.06 | 0.117 | 0.116 | 0.112 | 0.116 | 0.111 | 0.109 |
| L2 | SiO2 | 1.48 | 0.171 | 0.172 | 0.172 | 0.170 | 0.173 | 0.177 |
| L3 | ZrO2 | 2.06 | 0.181 | 0.178 | 0.173 | 0.171 | 0.162 | 0.154 |
| L4 | SiO2 | 1.48 | 0.128 | 0.137 | 0.144 | 0.154 | 0.167 | 0.180 |
| L5 | ZrO2 | 2.06 | 0.215 | 0.202 | 0.189 | 0.177 | 0.165 | 0.152 |
| L6 | SiO2 | 1.48 | 0.330 | 0.334 | 0.357 | 0.362 | 0.372 | 0.379 |

| L5 + L6 | 0.544 | 0.536 | 0.547 | 0.539 | 0.536 | 0.531 |
|---|---|---|---|---|---|---|
| | Average reflectance [%] | | | | | |
| 280 to 380 nm | 51 | 53 | 53 | 54 | 54 | 53 |
| 380 to 500 nm | 15 | 15 | 15 | 15 | 15 | 15 |
| 500 to 700 nm | 0.6 | 0.6 | 0.7 | 0.8 | 0.8 | 0.9 |
| Luminous reflectance [%] | 0.5 | 0.5 | 0.9 | 0.9 | 1.0 | 1.0 |
| YI value | 5.1 | 5.0 | 5.6 | 5.4 | 5.6 | 5.6 |

TABLE 2

| Film structure | | | | | | | | |
|---|---|---|---|---|---|---|---|---|
| | | Refractive | Example | Example | Example | Example | Example | Example |
| Layer | Material | index | A7 | A8 | A9 | A10 | A11 | A12 |
| | | | Optical film thickness (×λ) | | | | | |
| L1 | ZrO2 | 2.06 | 0.109 | 0.117 | 0.162 | 0.110 | 0.134 | 0.098 |
| L2 | SiO2 | 1.48 | 0.180 | 0.171 | 0.145 | 0.188 | 0.160 | 0.209 |
| L3 | ZrO2 | 2.06 | 0.148 | 0.181 | 0.172 | 0.167 | 0.187 | 0.125 |
| L4 | SiO2 | 1.48 | 0.199 | 0.128 | 0.195 | 0.156 | 0.156 | 0.201 |
| L5 | ZrO2 | 2.06 | 0.140 | 0.215 | 0.154 | 0.185 | 0.185 | 0.173 |
| L6 | SiO2 | 1.48 | 0.374 | 0.330 | 0.377 | 0.326 | 0.370 | 0.326 |

| L5 + L6 | 0.514 | 0.544 | 0.531 | 0.511 | 0.556 | 0.499 |
|---|---|---|---|---|---|---|
| | Average reflectance [%] | | | | | |
| 280 to 380 nm | 52 | 51 | 50 | 51 | 50 | 50 |
| 380 to 500 nm | 15 | 15 | 21 | 15 | 21 | 15 |
| 500 to 700 nm | 0.9 | 0.6 | 0.8 | 1.0 | 0.7 | 1.0 |
| Luminous reflectance [%] | 0.9 | 0.4 | 0.9 | 1.0 | 1.0 | 0.6 |
| YI value | 5.5 | 5.1 | 9.3 | 5.6 | 9.7 | 5.9 |

TABLE 3

| Film structure | | | | | | |
|---|---|---|---|---|---|---|
| | | Refractive | Comparative | Comparative | Comparative | Comparative |
| Layer | Material | index | example A1 | example A2 | example A3 | example A4 |
| | | | Optical film thickness (×λ) | | | |
| L1 | ZrO2 | 2.06 | 0.149 | 0.179 | 0.137 | 0.152 |
| L2 | SiO2 | 1.48 | 0.174 | 0.135 | 0.175 | 0.159 |
| L3 | ZrO2 | 2.06 | 0.156 | 0.185 | 0.147 | 0.178 |
| L4 | SiO2 | 1.48 | 0.159 | 0.195 | 0.229 | 0.147 |
| L5 | ZrO2 | 2.06 | 0.227 | 0.128 | 0.128 | 0.206 |
| L6 | SiO2 | 1.48 | 0.287 | 0.421 | 0.326 | 0.370 |
| L5 + L6 | | | 0.515 | 0.549 | 0.454 | 0.576 |

| | Average reflectance [%] | | | |
|---|---|---|---|---|
| 280 to 380 nm | 50 | 50 | 51 | 46 |
| 380 to 500 nm | 16 | 22 | 15 | 23 |
| 500 to 700 nm | 1.8 | 1.6 | 2.3 | 1.4 |
| Luminous reflectance [%] | 0.8 | 2.4 | 2.0 | 2.2 |
| YI value | 6.9 | 9.1 | 6.2 | 10.1 |

Table 4 indicated below indicates the optical film thicknesses (L1 to L7) of the respective layers, and a sum (L6+L7 corresponding to M+N as described above) of the optical film thicknesses of the final layer and the layer adjacent thereto in each film according to Examples B1 to B5 for the film type B. Table 5 indicates the optical film thicknesses of the respective layers and the like according to Examples B6 to B10 for the film type B. Table 6 indicates the optical film thicknesses of the respective layers and the like according to Examples B11 to B15 for the film type B. Table 7 indicates the optical film thicknesses of the respective layers and the like according to Comparative Examples B1 to B4 for the film type B.

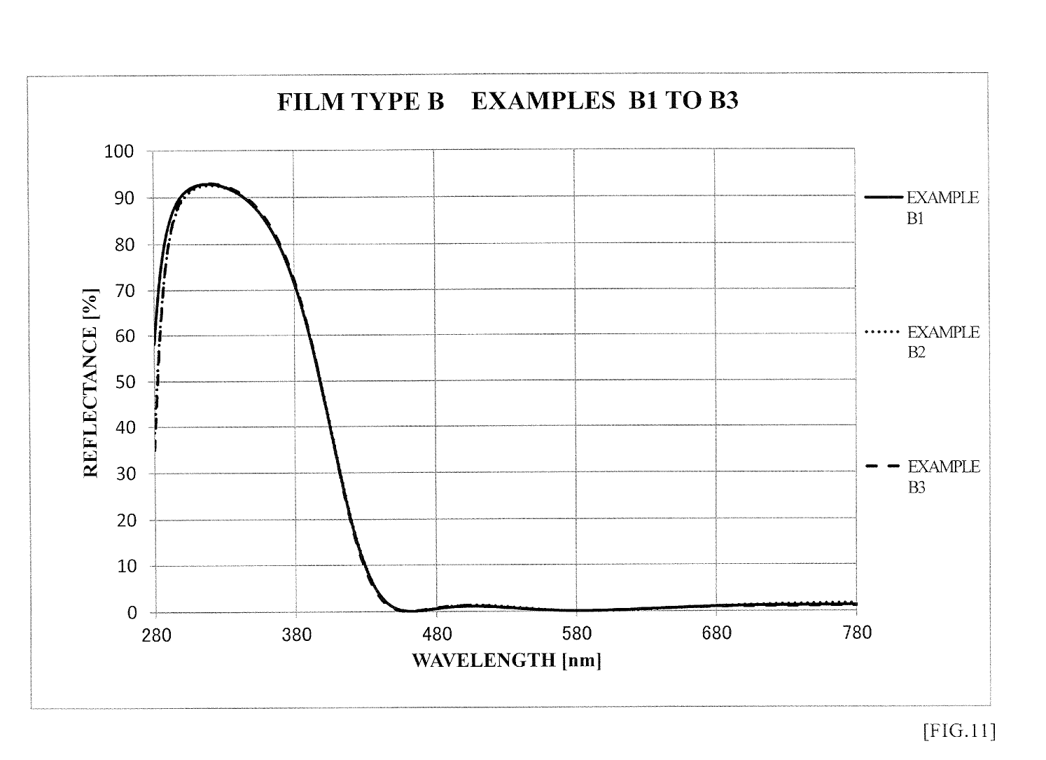

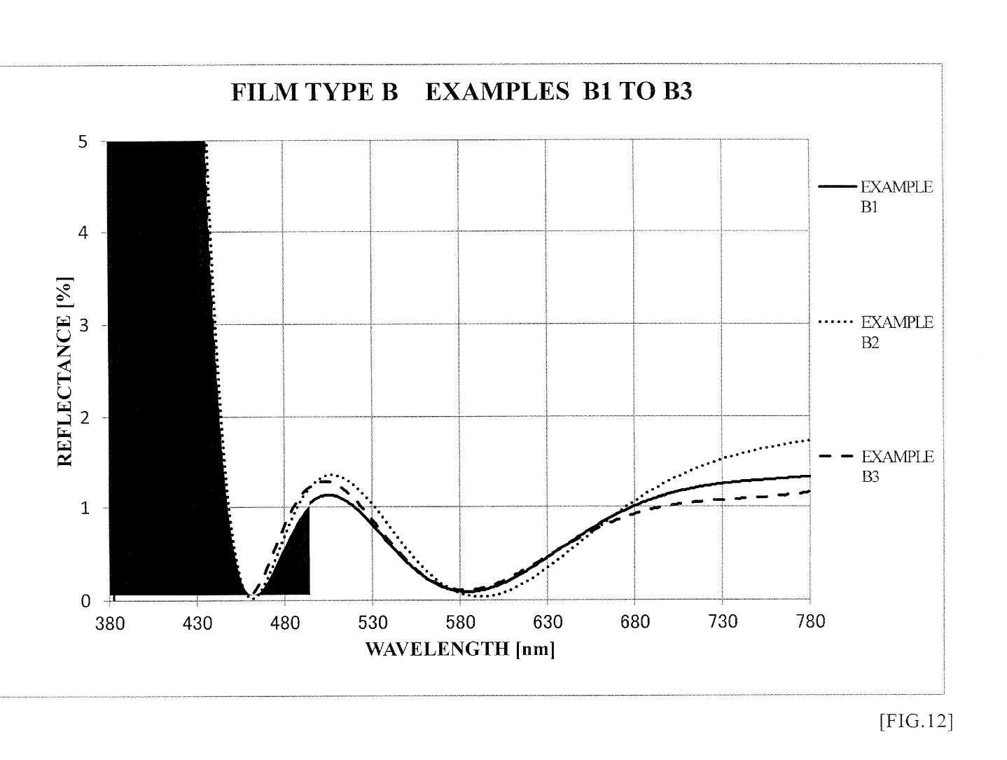

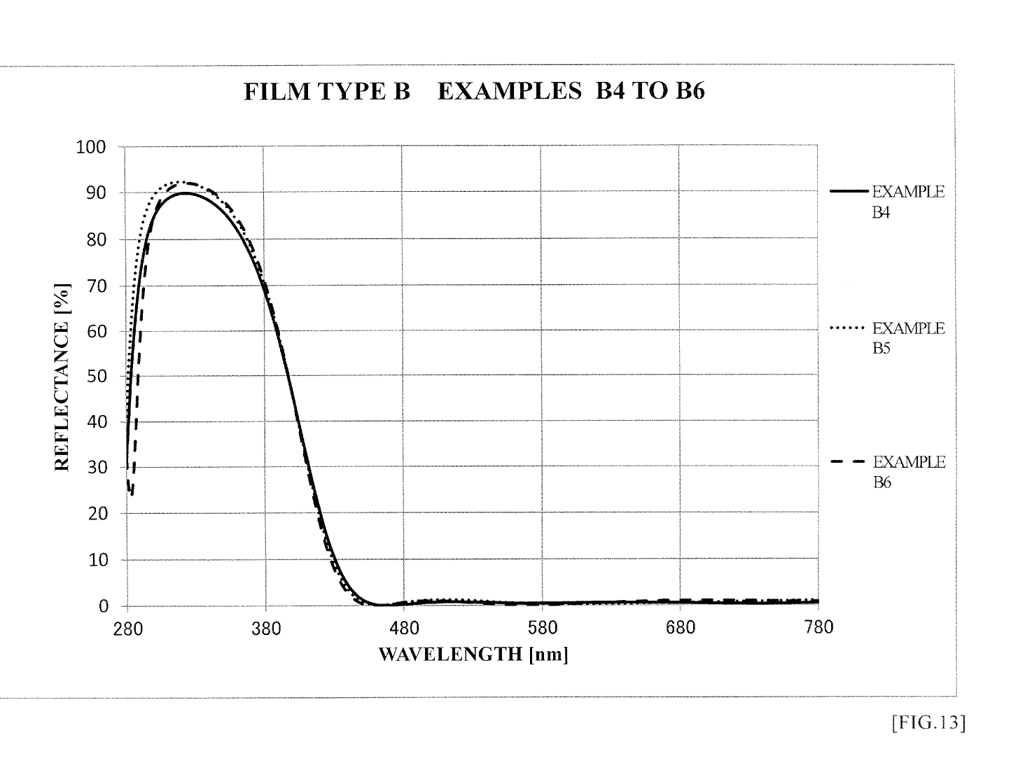

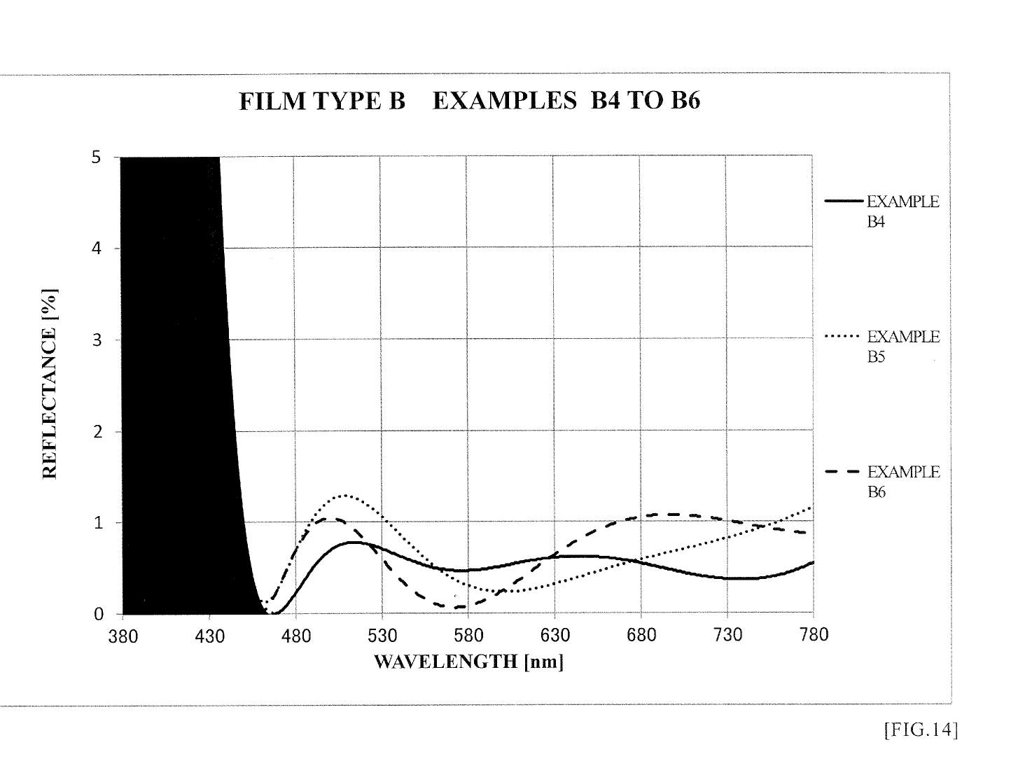

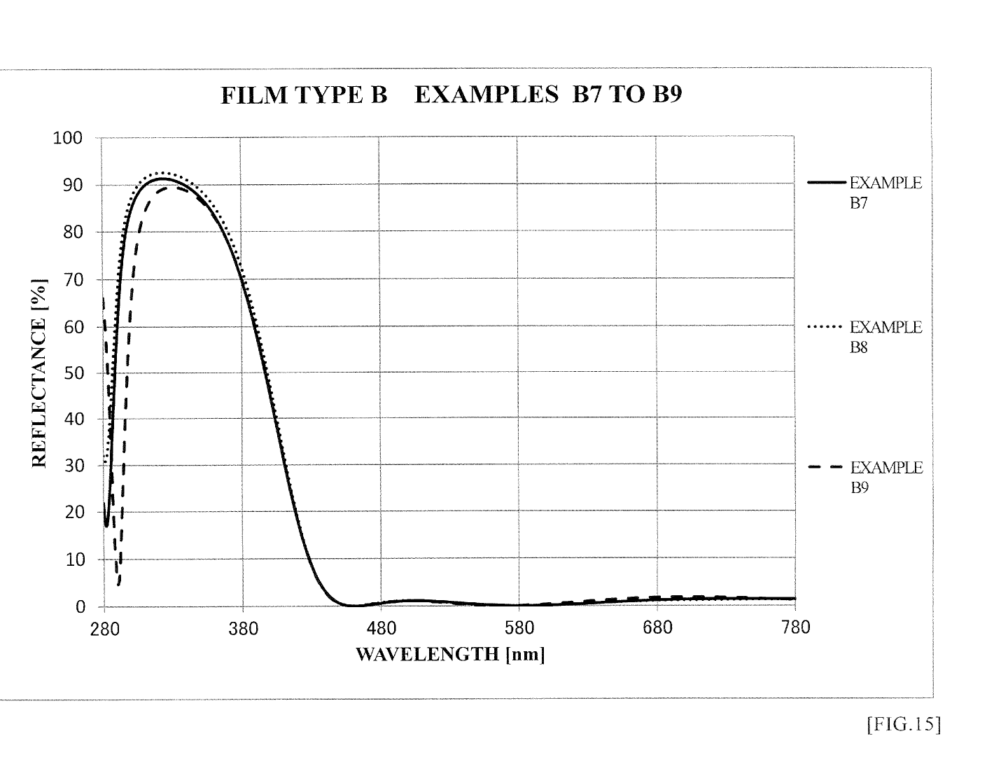

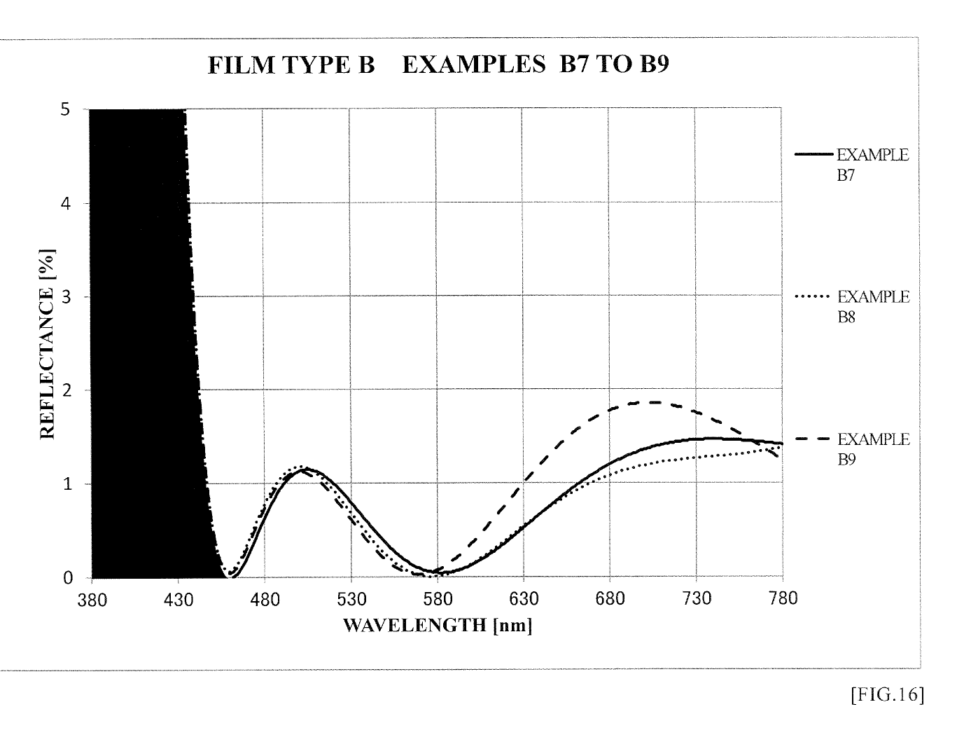

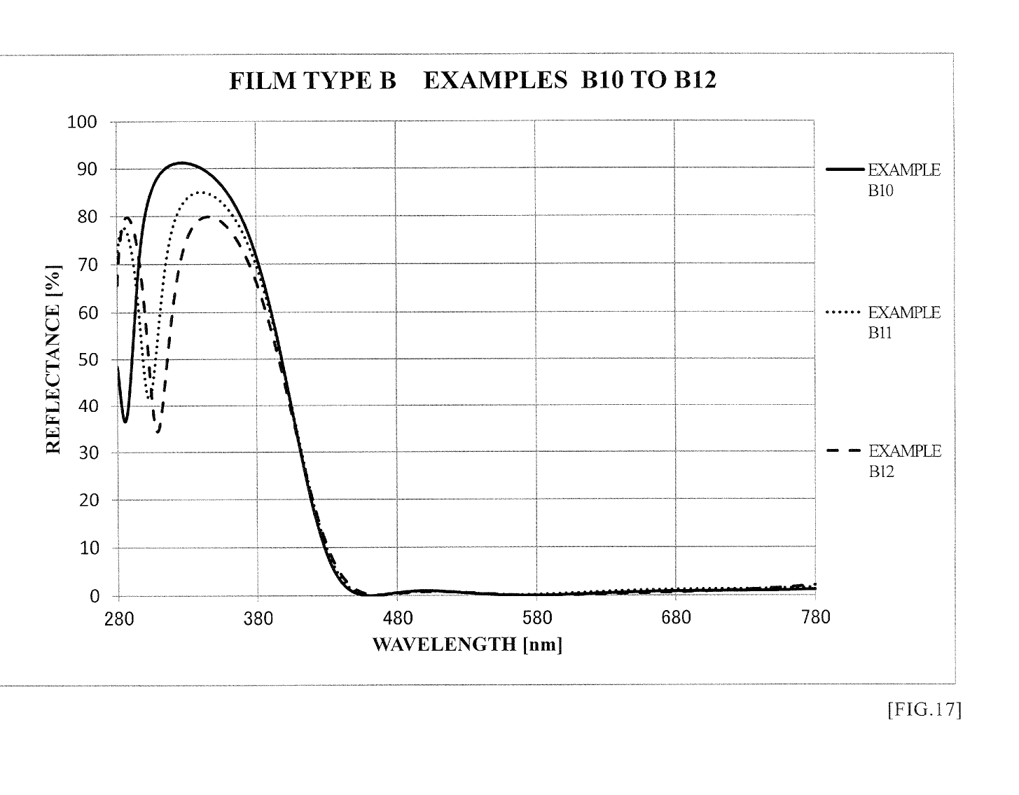

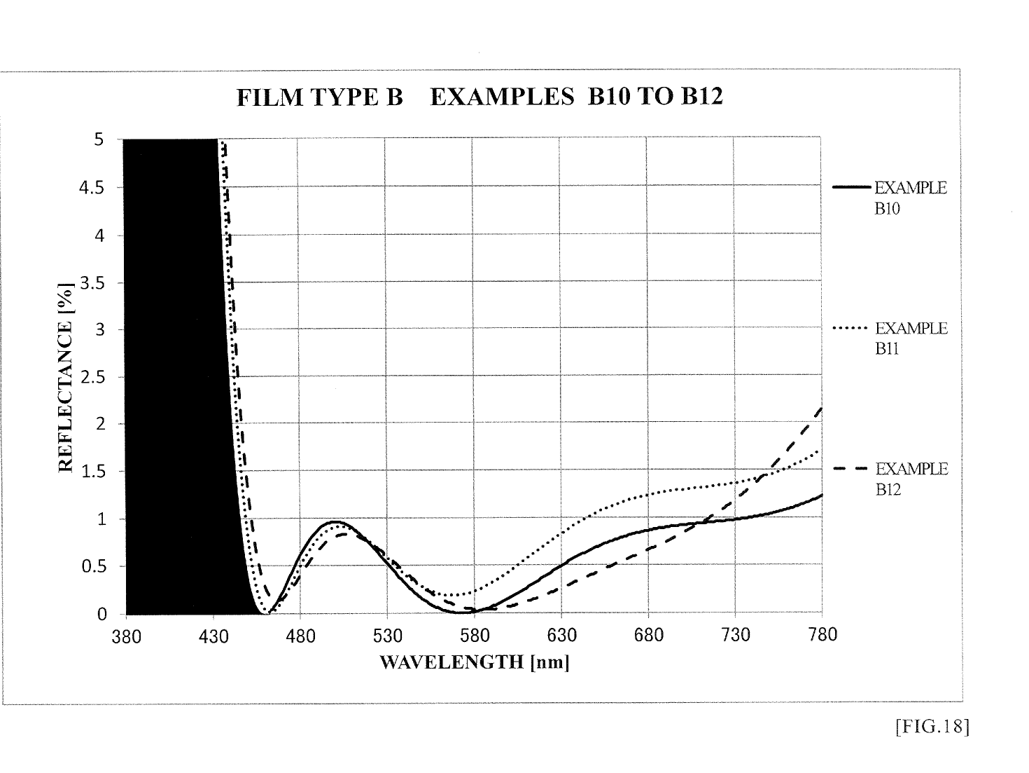

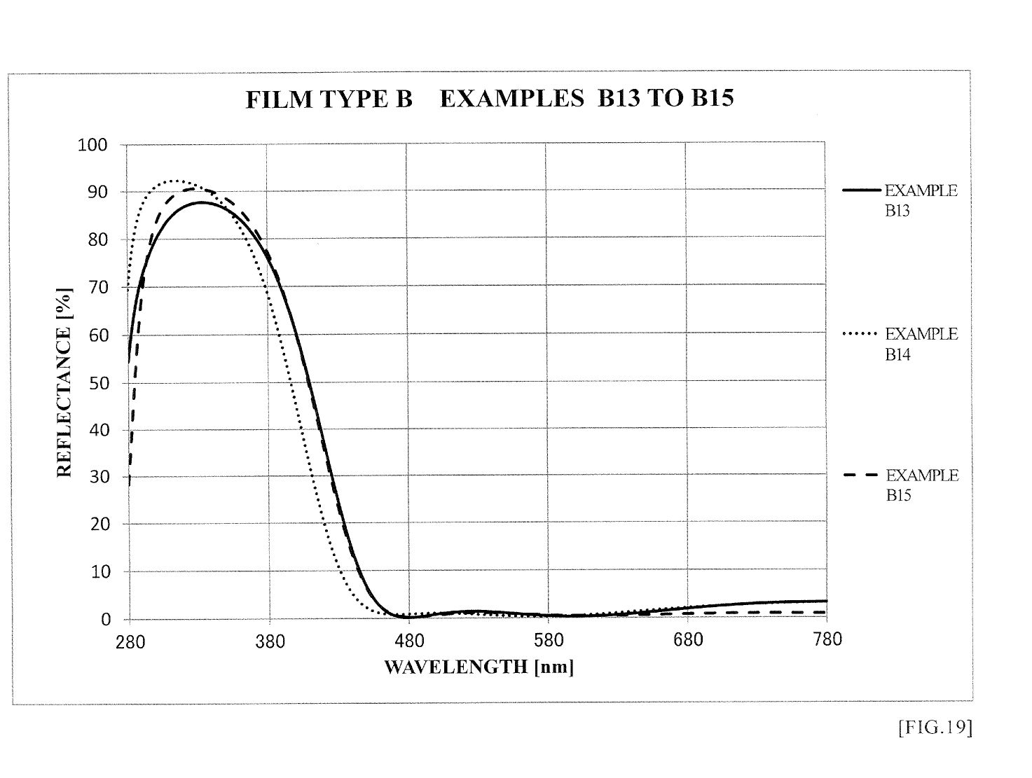

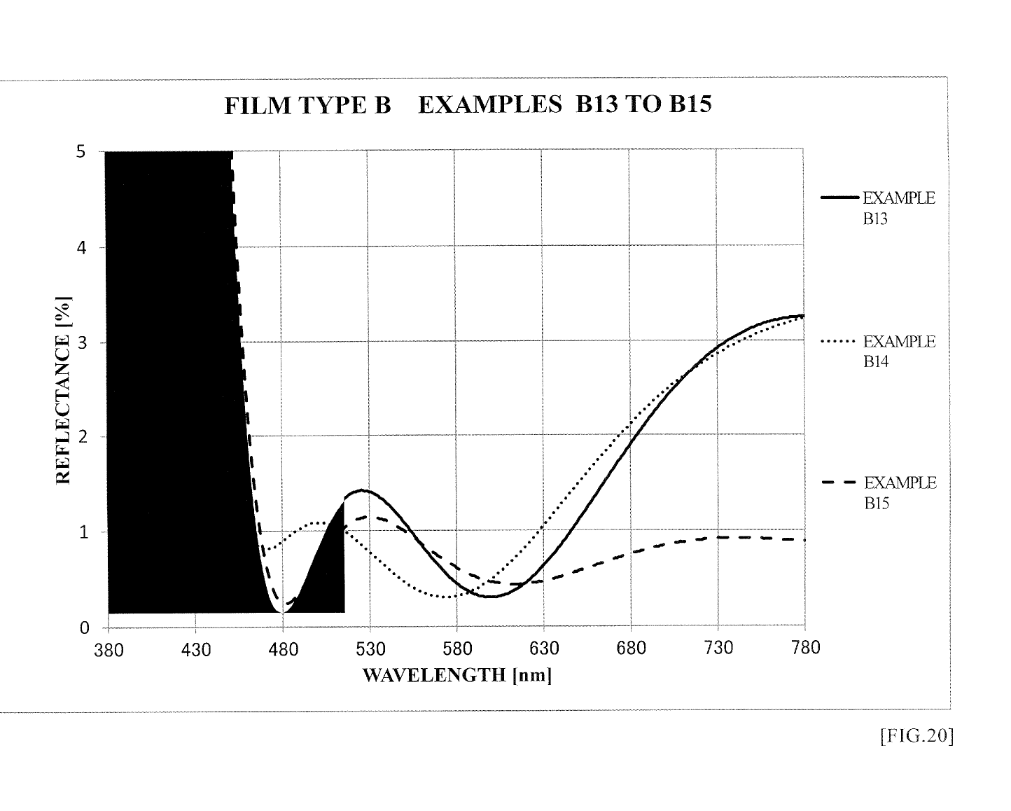

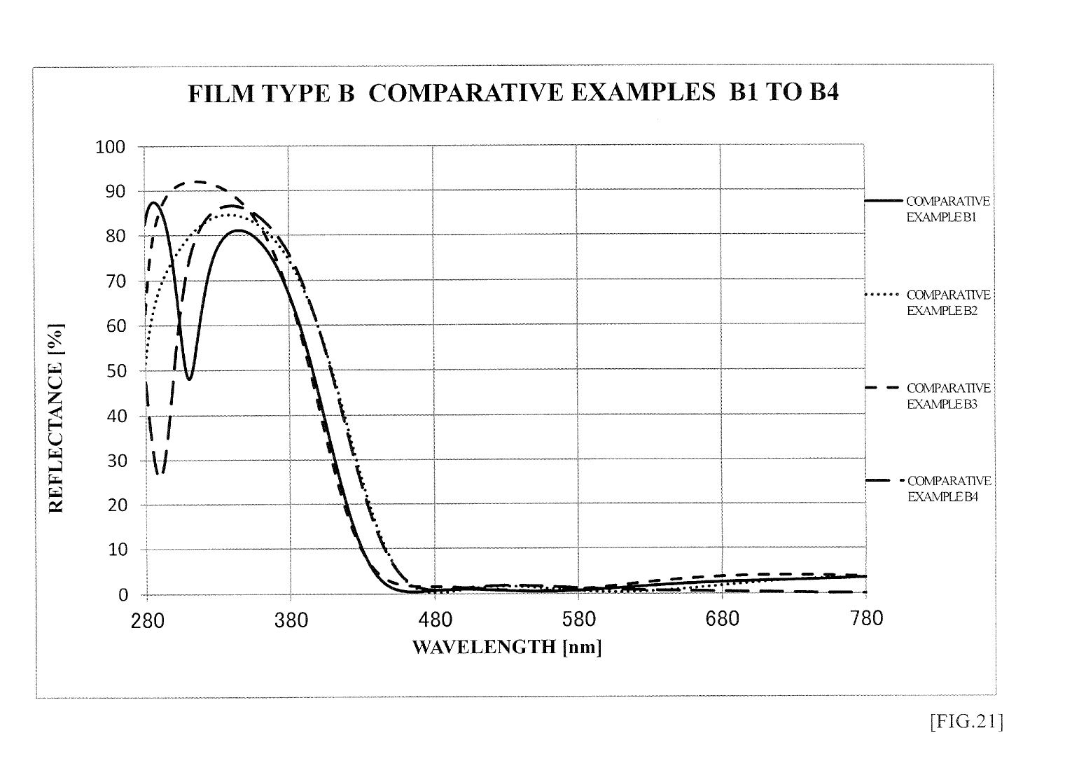

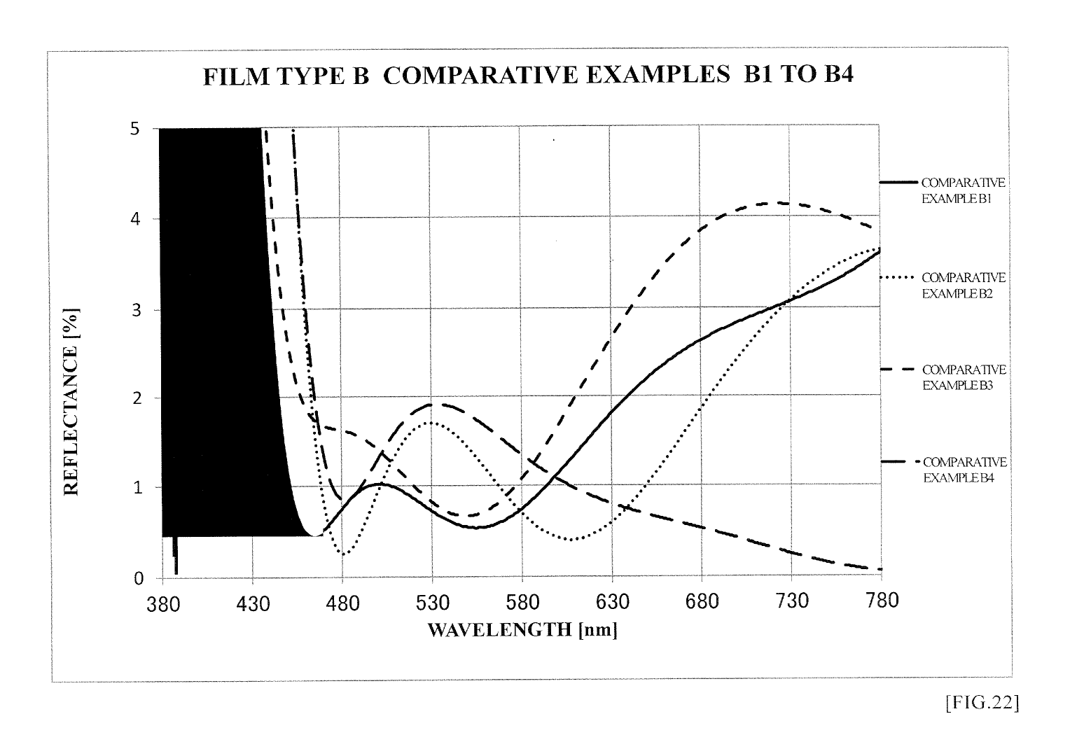

Further, FIG. 11 is a graph showing a distribution of reflectance according to Examples B1 to B3, and FIG. 12 is an enlarged view of FIG. 11. FIG. 13 is a graph showing a distribution of reflectance according to Examples B4 to B6, and FIG. 14 is an enlarged view of FIG. 13. FIG. 15 is a graph showing a distribution of reflectance according to Examples B7 to B9, and FIG. 16 is an enlarged view of FIG. 15. FIG. 17 is a graph showing a distribution of reflectance according to Examples B10 to B12, and FIG. 18 is an enlarged view of FIG. 17. FIG. 19 is a graph showing a distribution of reflectance according to Examples B13 to B15, and FIG. 20 is an enlarged view of FIG. 19. FIG. 21 a graph showing a distribution of reflectance according to Comparative examples B1 to B4, and FIG. 22 is an enlarged view of FIG. 21.

TABLE 4

| Film structure | | | | | | | |
|---|---|---|---|---|---|---|---|
| | | Refractive | Example | Example | Example | Example | Example |
| Layer | Material | index | B1 | B2 | B3 | B4 | B5 |
| | | | Optical film thickness (×λ) | | | | |
| L1 | SiO2 | 1.48 | 0.103 | 0.059 | 0.133 | 0.210 | 0.132 |
| L2 | TiO2 | 2.42 | 0.086 | 0.093 | 0.085 | 0.048 | 0.073 |
| L3 | SiO2 | 1.48 | 0.182 | 0.173 | 0.189 | 0.236 | 0.210 |
| L4 | TiO2 | 2.42 | 0.151 | 0.162 | 0.158 | 0.138 | 0.148 |
| L5 | SiO2 | 1.48 | 0.143 | 0.134 | 0.134 | 0.140 | 0.138 |
| L6 | TiO2 | 2.42 | 0.147 | 0.153 | 0.152 | 0.149 | 0.148 |
| L7 | SiO2 | 1.48 | 0.357 | 0.348 | 0.346 | 0.350 | 0.347 |

| L6 + L7 | 0.504 | 0.501 | 0.498 | 0.500 | 0.495 |
|---|---|---|---|---|---|
| | Average reflectance [%] | | | | |
| 280 to 380 nm | 86 | 85 | 85 | 81 | 85 |
| 380 to 500 nm | 18 | 18 | 18 | 17 | 17 |
| 500 to 700 nm | 0.6 | 0.6 | 0.6 | 0.6 | 0.6 |
| Luminous reflectance [%] | 0.5 | 0.6 | 0.5 | 0.6 | 0.7 |
| YI value | 4.7 | 4.8 | 4.5 | 4.7 | 4.5 |

TABLE 5

| Film structure | | | | | | | |
|---|---|---|---|---|---|---|---|
| | | Refractive | Example | Example | Example | Example | Example |
| Layer | Material | index | B6 | B7 | B8 | B9 | B10 |
| | | | Optical film thickness (×λ) | | | | |
| L1 | SiO2 | 1.48 | 0.116 | 0.030 | 0.133 | 0.053 | 0.169 |
| L2 | TiO2 | 2.42 | 0.097 | 0.100 | 0.092 | 0.119 | 0.082 |
| L3 | SiO2 | 1.48 | 0.157 | 0.146 | 0.178 | 0.119 | 0.184 |
| L4 | TiO2 | 2.42 | 0.186 | 0.187 | 0.170 | 0.219 | 0.173 |
| L5 | SiO2 | 1.48 | 0.115 | 0.118 | 0.119 | 0.108 | 0.107 |
| L6 | TiO2 | 2.42 | 0.164 | 0.161 | 0.170 | 0.162 | 0.187 |
| L7 | SiO2 | 1.48 | 0.343 | 0.345 | 0.334 | 0.348 | 0.326 |

| L6 + L7 | 0.508 | 0.506 | 0.504 | 0.510 | 0.513 |
|---|---|---|---|---|---|
| | Average reflectance [%] | | | | |
| 280 to 380 nm | 80 | 79 | 82 | 74 | 80 |
| 380 to 500 nm | 17 | 17 | 18 | 17 | 17 |
| 500 to 700 nm | 0.6 | 0.6 | 0.6 | 0.9 | 0.5 |
| Luminous reflectance [%] | 0.4 | 0.5 | 0.4 | 0.5 | 0.4 |
| YI value | 4.1 | 4.4 | 4.5 | 4.2 | 4.4 |

TABLE 6

| Film structure | | | | | | | |
|---|---|---|---|---|---|---|---|
| | | Refractive | Example | Example | Example | Example | Example |
| Layer | Material | index | B11 | B12 | B13 | B14 | B15 |
| | | | Optical film thickness (×λ) | | | | |
| L1 | SiO2 | 1.48 | 0.182 | 0.175 | 0.110 | 0.064 | 0.061 |
| L2 | TiO2 | 2.42 | 0.089 | 0.078 | 0.091 | 0.078 | 0.097 |
| L3 | SiO2 | 1.48 | 0.165 | 0.179 | 0.206 | 0.214 | 0.171 |
| L4 | TiO2 | 2.42 | 0.200 | 0.206 | 0.110 | 0.118 | 0.166 |
| L5 | SiO2 | 1.48 | 0.072 | 0.056 | 0.234 | 0.188 | 0.153 |
| L6 | TiO2 | 2.42 | 0.242 | 0.262 | 0.092 | 0.121 | 0.145 |
| L7 | SiO2 | 1.48 | 0.303 | 0.296 | 0.415 | 0.341 | 0.385 |

| L6 + L7 | 0.544 | 0.559 | 0.507 | 0.462 | 0.530 |
|---|---|---|---|---|---|
| | Average reflectance [%] | | | | |
| 280 to 380 nm | 74 | 69 | 82 | 86 | 82 |
| 380 to 500 nm | 17 | 18 | 26 | 18 | 26 |
| 500 to 700 nm | 0.7 | 0.4 | 1.0 | 1.0 | 0.7 |
| Luminous reflectance [%] | 0.5 | 0.4 | 1.0 | 0.7 | 0.9 |
| YI value | 4.5 | 5.1 | 10.0 | 5.2 | 9.7 |

TABLE 7

| Film structure | | | | | | |
|---|---|---|---|---|---|---|
| | | Refractive | Comparative | Comparative | Comparative | Comparative |
| Layer | Material | index | example B1 | example B2 | example B3 | example B4 |
| | | | Optical film thickness (×λ) | | | |
| L1 | SiO2 | 1.48 | 0.172 | 0.101 | 0.115 | 0.100 |
| L2 | TiO2 | 2.42 | 0.095 | 0.092 | 0.087 | 0.085 |
| L3 | SiO2 | 1.48 | 0.172 | 0.207 | 0.208 | 0.165 |
| L4 | TiO2 | 2.42 | 0.188 | 0.104 | 0.110 | 0.207 |
| L5 | SiO2 | 1.48 | 0.064 | 0.251 | 0.221 | 0.101 |
| L6 | TiO2 | 2.42 | 0.276 | 0.081 | 0.097 | 0.179 |
| L7 | SiO2 | 1.48 | 0.282 | 0.430 | 0.341 | 0.385 |

| L6 + L7 | 0.557 | 0.511 | 0.437 | 0.564 |
|---|---|---|---|---|
| | Average reflectance [%] | | | |
| 280 to 380 nm | 74 | 78 | 85 | 71 |
| 380 to 500 nm | 18 | 26 | 17 | 26 |
| 500 to 700 nm | 1.4 | 1.2 | 2.0 | 1.1 |
| Luminous reflectance [%] | 0.9 | 1.2 | 1.2 | 1.6 |
| YI value | 4.2 | 10.6 | 4.4 | 9.9 |

Each table indicates the average reflectance for light having wavelengths that are greater than or equal to 280 nm and not greater than 380 nm, the average reflectance for light having wavelengths that are greater than or equal to 380 nm and not greater than 500 nm, the average reflectance for light having wavelengths that are greater than or equal to 500 nm and not greater than 700 nm, the luminous reflectance (D65 light source, viewing angle of 2 degrees); and the YI value.

The YI value is represented, according to the following equation, by using tri-stimulus values X, Y, Z of a test sample in the standard illuminant in the XYZ color system.

YI=100(1.2769X−1.059Z)/Y

When the YI value is minus, the tint becomes bluish. When the YI value is plus, the tint becomes yellowish or reddish. The XYZ color system is adopted as a standard color system by the CIE (International Commission on Illumination), and is a system based on red, green, and blue that are the three primary colors of light, or additive mixture thereof. A colorimeter for obtaining the stimulus values X, Y, Z in the XYZ color system is publicly known. Multiplication, of spectral energy of light to be measured, by a color-matching function for each of the stimulus values X, Y, Z for each wavelength, is performed and the results of the multiplication over all the wavelengths in a visible region are accumulated, to obtain the stimulus values X, Y, Z.

In Comparative example A1, the optical film thickness (L6) of the final layer is 0.287λ, and is slightly less than the lower limit of 0.295λ≦M≦0.415λ. Therefore, the central-section-in-visible-region average reflectance is 1.8%, and extremely excellent visibility of visible light (visibility is excellent when the central-section-in-visible-region average reflectance is less than or equal to 1%) cannot be assured.

In Comparative example A2, the optical film thickness (L6) of the final layer is 0.421λ, and is slightly greater than the upper limit of 0.295λ≦M≦0.415λ. Therefore, the central-section-in-visible-region average reflectance is 1.6% and the luminous reflectance is 2.4%, and extremely excellent visibility of visible light (visibility is excellent when the central-section-in-visible-region average reflectance and the luminous reflectance are each less than or equal to 1%) cannot be assured.

In Comparative example A3, a sum (L5+L6) of the optical film thicknesses of the final layer and the layer adjacent thereto is 0.454λ, and is slightly less than the lower limit of 0.460λ≦M+N≦0.560λ. Therefore, the central-section-in-visible-region average reflectance is 2.3% and the luminous reflectance is 2.0%, and extremely excellent visibility of visible light cannot be assured.

In Comparative example A4, a sum (L5+L6) of the optical film thicknesses of the final layer and the layer adjacent thereto is 0.576λ, and is slightly greater than the upper limit of 0.460λ≦M+N≦0.560λ. Therefore, the ultraviolet average reflectance is 46%, the central-section-in-visible-region average reflectance is 1.4%, and the luminous reflectance is 2.2%. Therefore, an appropriate ultraviolet shielding function (the function is appropriate when the ultraviolet average reflectance is greater than or equal to 50% and not greater than 86%) and extremely excellent visibility of visible light (the visibility is excellent when the central-section-in-visible-region average reflectance and the luminous reflectance are each less than or equal to 1%) cannot be assured. In Comparative example A4, the YI value is 10.1, and yellowish or reddish tint is relatively strong in the optical multiplayer film. Thus, excellent visibility or advantageous outer appearance (visibility is excellent or outer appearance is advantageous when the YI value is less than or equal to 10) cannot be assured. When the yellowish tint or reddish tint is strong, the tint is yellowish (reddish) in the field of view, and a portion of the spectacle around eyes becomes yellowish or reddish, and an outer appearance becomes unique. Therefore, such an outer appearance tends to be avoided.

On the other hand, in Examples A1 to A12, conditions of 0.295λ≦M≦0.415λ and 0.460λ≦M+N≦0.560λ are both satisfied. Therefore, the ultraviolet average reflectance is greater than or equal to 50% and not greater than 86%, the blue light average reflectance is greater than or equal to 15% and not greater than 26%, and the central-section-in-visible-region average reflectance is less than or equal to 1.0%. Further, the luminous reflectance is less than or equal to 1.0%. Furthermore, the YI value is less than or equal to 10.0.

Therefore, while both blue light and ultraviolet rays are cut off, extremely advantageous visibility can be assured, and an advantageous outer appearance can be also assured. Since blue light and ultraviolet rays are cut off, eyes can be protected in the case of spectacles. Further, even when the optical multilayer film according to Examples A1 to A12 is provided in the optical product that contains ultraviolet absorber in a base, ultraviolet rays can be cut off already in the optical multilayer film. Therefore, the base and an intermediate film such as a hard coating film can be protected from ultraviolet rays. Further, as excellent visibility in the visible region can be simultaneously assured, the present invention is suitable for spectacles, camera filters, display films, and the like.

In Comparative example B1, the optical film thickness (L7) of the final layer is 0.282λ, and is slightly less than the lower limit of 0.295λ≦M≦0.415λ. Therefore, the central-section-in-visible-region average reflectance is 1.4%, and extremely excellent visibility of visible light cannot be assured.

In Comparative example B2, the optical film thickness (L7) of the final layer is 0.430λ, and is slightly greater than the upper limit of 0.295λ≦M≦0.415λ. Therefore, the central-section-in-visible-region average reflectance is 1.2% and the luminous reflectance is 1.2%, and extremely excellent visibility of visible light cannot be assured. In Comparative example B2, the YT value is 10.6, and the yellowish or reddish tint is strong.

In Comparative example 133, a sum (L6+L7) of the optical film thicknesses of the final layer and the layer adjacent thereto is 0.437λ, and is slightly less than the lower limit of 0.460λ≦M+N≦0.560λ. Therefore, the central-section-in-visible-region average reflectance is 2.0% and the luminous reflectance is 1.2%, and extremely excellent visibility of visible light cannot be assured.

In Comparative example 134, a sum (L6+L7) of the optical film thicknesses of the final layer and the layer adjacent thereto is 0.564λ, and is slightly greater than the upper limit of 0.460λ≦M+N≦0.560λ. Therefore, the central-section-in-visible-region average reflectance is 1.1% and the luminous reflectance is 1.6%, and extremely excellent visibility of visible light cannot be assured.

On the other hand, in Examples B1 to B15, conditions of 0.295λ≦M≦0.415λ and 0.460λ≦M+N≦0.560λ are both satisfied. Therefore, the ultraviolet average reflectance is greater than or equal to 50% and not greater than 86%, the blue light average reflectance is greater than or equal to 15% and not greater than 26%, and the central-section-in-visible-region average reflectance is less than or equal to 1.0%. Further, the luminous reflectance is less than or equal to 1.0%. Furthermore, the YI value is less than or equal to 10.0.

Therefore, while both blue light and ultraviolet rays are cut off, extremely advantageous visibility can be assured, and an advantageous outer appearance can be also assured.

1. An optical product comprising:
a base; and
an optical multilayer film formed on a surface of the base, wherein
the optical multilayer film includes six or more layers in which a low refractive index layer and a high refractive index layer are alternately disposed where a first layer is closest to the base and a final layer is the low refractive index layer,
and further includes the final layer having an optical film thickness M and a layer adjacent to the final layer having an optical film thickness N, in which a sum M+N of the optical film thickness M and the optical film thickness N satisfies following conditions, respectively,
when a design wavelength λ=500 nm is satisfied.
0.295λ≦M≦0.415λ
0.460λ≦M+N≦0.560λ

2. The optical product according to claim 1, wherein
in the optical multilayer film,
an average reflectance for light in a range of wavelengths that are greater than or equal to 280 nm and not greater than 380 nm, is greater than or equal to 50% and not greater than 86%, and
an average reflectance for light in a range of wavelengths that are greater than or equal to 380 nm and not greater than 500 nm, is greater than or equal to 15% and not greater than 26%.

3. The optical product according to claim 1, wherein, in the optical multilayer film, an average reflectance for light in a range of wavelengths that are greater than or equal to 500 nm and not greater than 700 nm, is less than or equal to 1.0%.

4. The optical product according to claim 2, wherein, in the optical multi layer film, an average reflectance for light in a range of wavelengths that are greater than or equal to 500 nm and not greater than 700 nm, is less than or equal to 1.0%.

5. The optical product according to claim 1, wherein
a luminous reflectance (D65 light source, viewing angle of 2 degrees) in the optical multilayer film is less than or equal to 1.0%.

6. The optical product according to claim 2, wherein
a luminous reflectance (D65 light source, viewing angle of 2 degrees) in the optical multilayer film is less than or equal to 1.0%.

7. The optical product according to claim 3, wherein
a luminous reflectance (D65 light source, viewing angle of 2 degrees) in the optical multilayer film is less than or equal to 1.0%.

8. The optical product according to claim 4, wherein
a luminous reflectance (D65 light source, viewing angle of 2 degrees) in the optical multilayer film is less than or equal to 1.0%.

9. A spectacle lens comprising the optical product according to claim 1, wherein the base is a spectacle lens base.

10. A spectacle lens comprising the optical product according to claim 2, wherein the base is a spectacle lens base.

11. A spectacle lens comprising the optical product according to claim 3, wherein the base is a spectacle lens base.

12. A spectacle lens comprising the optical product according to claim 4, wherein the base is a spectacle lens base.

13. A spectacle lens comprising the optical product according to claim 5, wherein the base is a spectacle lens base.

14. A spectacle lens comprising the optical product according to claim 6, wherein the base is a spectacle lens base.

15. A spectacle lens comprising the optical product according to claim 7, wherein the base is a spectacle lens base.

16. A spectacle lens comprising the optical product according to claim 8, wherein the base is a spectacle lens base.
